(19) United States
(12) Patent Application Publication
(10) Pub. No.: US 2006/0285683 A1
(43) Pub. Date: Dec. 21, 2006

(54) Method for cryptographically processing a message, method for generating a cryptographically processed message, method for performing a cryptographic operation on a message, computer system, client computer, server computer and computer program elements

(76) Inventors: Lakshminarayanan Anatharaman, Singapore (SG); Feng Bao, Singapore (SG); Huijie Deng, Singapore (SG)

Correspondence Address: FOLEY AND LARDNER LLP;SUITE 500, 3000 K STREET NW, WASHINGTON, DC, 20007, US

(21) Appl. No.: 10/574,222

(22) PCT Filed: Oct. 1, 2004
(86) PCT No.: PCT/SG04/00320

§ 371 Date: Mar. 31, 2006

(51) Int. Cl. H04L 9/30

(52) U.S. Cl. 380/30

(57) ABSTRACT

A method for cryptographically processing a message is disclosed, wherein a first partial cryptographic key and a second partial cryptographic key, which correspond to a decomposition of a private cryptographic key, are used, the message is processed using the first partial cryptographic key resulting in a first partially processed message, the message is processed using the second partial cryptographic key resulting in a second partially processed message and the first partially processed message and the second partially processed message are combined resulting in a cryptographically processed message.

Method for cryptographically processing a message, method for generating a cryptographically processed message, method for performing a cryptographic operation on a message, computer system, client computer, server computer and computer program elements

The invention relates to a method for cryptographically processing a message, a method for generating a cryptographically processed message, a method for performing a cryptographic operation on a message, a computer system, a client computer, a server computer and computer program elements.

The number of people using computer networks for data transfers, particularly the Internet, has significantly increased in the last years.

Some of the data transferred using a computer network or stored in a computer network is often secret, e.g. it should not be read or changed by people who are not privileged to do so.

Therefore, information (or data) security solutions and network security solutions, i.e. methods for guaranteeing security of computer networks, for example for preventing that non-authorized people access the computer network and/or the data transferred in the computer network, are of major importance.

Existing information security solutions and network security solutions are barely keeping pace with the sophistication of attack methodologies. Most of the network security products on the market fall into two categories:
Products for the prevention of attacks at the boundary between two computer networks (for example firewalls)
Products for the detection of an attack after the attack has happened (for example intrusion detection systems).

Firewalls are designed to protect computer systems in a computer network from hackers who attack from outside the computer network, but not from malicious insiders, i.e., from people who access the computer network from the inside, e.g. by a computer system which is part of the computer network. Firewalls concentrate security at one port, aggravating the single point of failure phenomenon. Intrusion detection systems can only detect an attack after the damage has been done. Hackers normally work faster to come out with new attack methodologies to avoid being detected.

Application server computers which make use of public key cryptographic (PKC) systems for securing data transfers are playing an increasingly important role in the Internet, for example in electronic commerce. Such application server computers are for example web server computers that serve Internet client computers, like a web server computer hosting the web site of a bank and transferring the state of an account of a user to an Internet client computer used by that user.

Most of the web server computers use the SSL (Secure sockets layer) protocol to protect the communications with the client computers, i.e., to guarantee secure data transfers. The SSL protocol employs PKC and is the de-facto security protocol for web security. Security of PKC based application server computers depends on the secrecy of the private key of the PKC. If the private key is compromised, the entire system is compromised and the consequence is that the transfer of data which is encrypted based on the private key and its corresponding public key is no longer secure.

An application server computer used by an enterprise, such as a web server computer which hosts a web page of the enterprise, has typically to be placed outside the firewall of the enterprise's computer network, i.e., in a publicly accessible computer network separated from the enterprise's computer network by the firewall, such that web client computers are able to access the web server computer.

In particular, the web server computer is not protected by the firewall. This makes the web server computer vulnerable to attacks. If the web server computer carries a private key which is used for secure data transfer by an underlying PKC, the web server computer becomes a vulnerable point of failure. In [1], the RSA algorithm, which is the most popular PKC algorithm, is described.

An object of the invention is to prevent the security problems which arise when a private key is stored on a computer which is vulnerable to attacks.

The object is achieved by a method for cryptographically processing a message, a method for generating a cryptographically processed message, a method for performing a cryptographic operation on a message, a computer system, a client computer, a server computer and computer program elements with the features according to the independent claims.

A method for cryptographically processing a message is provided, wherein a first partial cryptographic key and a second partial cryptographic key, which correspond to a decomposition of a private cryptographic key, are used; the message is processed using the first partial cryptographic key resulting in a first partially processed message; the message is processed using the second partial cryptographic key resulting in a second partially processed message; and the first partially processed message and the second partially processed message are combined resulting in a cryptographically processed message.

Further, a method for generating a cryptographically processed message, a method for performing a cryptographic operation on a message, a computer system, a client computer, a server computer and computer program elements according to the method for cryptographically processing a message described above are provided.

Illustratively, a method for protecting a private key (e.g. a RSA key) by splitting the private key into multiple key parts is provided. Partial operations corresponding to the multiple key parts are performed separately and the results are later combined. Thus, it is possible that the partial operations are carried out on separate computers and in particular, that on each computer only a key part—not the complete private key—has to be stored.

The private cryptographic key is at least decomposed into two partial cryptographic keys. To achieve even more security, however, the private cryptographic key can be decomposed into a multiplicity of partial cryptographic keys which are stored on different key server computers. Accordingly, each of the multiplicity of key server computers can perform a partial operation using the partial cryptographic key stored in the key server computer and send the result to some server computer which combines the results.

For example, the key parts are stored in an application server computer and in one or more key server computers. In one embodiment, the key server computers each carry out a partial private key cryptographic operation, e.g. compute a partial signature or a partial decryption, and send the results to the application server computer which assembles the results to form the result of the complete private key cryptographic operation, e.g. the complete signature or decryption. Alternatively, the application server computer computes a partial signature or a partial decryption itself and combines it with the results from the key server computers.

The procedure is for example controlled by an administrator managing the key parts on different key server computers and application server computers and who creates key-pairs (consisting each of a private key and a public key) and managing them during their entire life-time. In one embodiment, an efficient mechanism for refreshing the key parts and a mechanism for splitting a RSA private exponent, such that efficient computation is achieved, is used. These two mechanisms can also be controlled by an administrator. Further, load balancing techniques can be used such that the cryptographical operations can be distributed to the key server computers. In existing prior art, a private key of an application server computer has to be duplicated on all load balancing server computers or all the load balancing server computers share a common private key. (A -load balancing server computer is in this case a computer performing cryptographic operations for the application server computer based on the private key, i.e., “helping” the application server computer at performing cryptographic operations.) However, this makes the private key more vulnerable to attacks since each of the load balancing server computers might be subject to an attack. The method according to the invention provides much better security and scalability at the same time. By splitting the private key in different ways and sharing the private key parts with different key server computers, the security of the system is not compromised if some of the key server computers fail or are successfully attacked.

For example, a private key is split in a first and a second part and the first part is stored in a publicly accessible application server computer and the second part is stored in a key server computer. If an attacker succeeds in getting the first part, he still needs to compromise the key server computer to obtain the second part. Since the first part and the second part are preferably regularly refreshed, it will be difficult for the attacker to obtain both parts unless the application server computer and the key server computer are compromised at around the same time.

Illustratively, instead of just preventing or simply detecting attacks, according to the invention, e-immunity is built into a computer system so that the computer system is tolerant to intrusions and attacks—it can maintain the overall system security even when individual components are repeatedly broken into and controlled by an attacker.

Preferred embodiments of the invention are given by the dependent claims. The embodiments which are described in the context of the method for cryptographically processing a message are analogously valid for the method for generating a cryptographically processed message, the method for performing a cryptographic operation on a message, the computer system, the client computer, the server computer and the computer program elements.

It is preferred that the processing of the message using the first partial cryptographic key is carried out by a first computer and the processing of the message using the second partial cryptographic key is carried out by a second computer.

Preferably, the first and the second computer are coupled via a computer network.

For example, the first computer is located in a publicly accessible computer network and the second computer is located in a secure computer network coupled to the publicly accessible computer network.

It is further preferred that the method further comprises the step of transmitting the message from the first computer to the second computer.

It is further preferred that the first partial cryptographic key and the second partial cryptographic key correspond to a decomposition of the private cryptographic key into a plurality of partial cryptographic keys.

Preferably, the plurality of partial cryptographic keys give, when summed, the private cryptographic key.

In other words, this means that the private cryptographic key is decomposed into a sum of partial cryptographic keys.

It is further preferred that the cryptographical processing of the message is the signing of the message or the decrypting of a message.

It is preferred that the message is processed according to a public key cryptographic algorithm.

In a public key cryptographic algorithm, there exists a public cryptographic key for decrypting a message and a private cryptographic key for decrypting (signing) a message. Typically, before a secret message is sent, a pair consisting of a private cryptographic key and a public cryptographic key are generated. The private cryptographic key and the public cryptographic key are for example large integers (e.g. with more than 100 binary digits). The message is encrypted using the public cryptographic key and is then sent to a receiver. The receiver can decrypt the message using the private key. Since the message can only be decrypted using the private key and the private key is kept secret by the receiver, the message can not be decrypted by some unauthorized person.

Preferably, the public key cryptographic algorithm is the RSA algorithm.

The invention can also be applied to other cryptographic methods than RSA, for example to other assymetric cryptographic methods, key generating algorithms or other signing methods. In general, the invention can be used with every algorithm were the result (for example the decrypted or signed message) is given by some function f which fulfils f(x+y)=f(x)f(y) were x and y are cryptographic key parts. For example, cryptographic methods which are based on the discrete logarithm satisfy this prerequisite.

It is further preferred that at selected times and after or before the message is processed, a refreshed decomposition is determined.

Preferably, the refreshed decomposition is determined by decomposing the first partial cryptographic key and the second partial cryptographic key and combining these decompositions to form a decomposition of the private cryptographic key.

Illustrative embodiments of the invention are explained below with reference to the drawings, wherein:

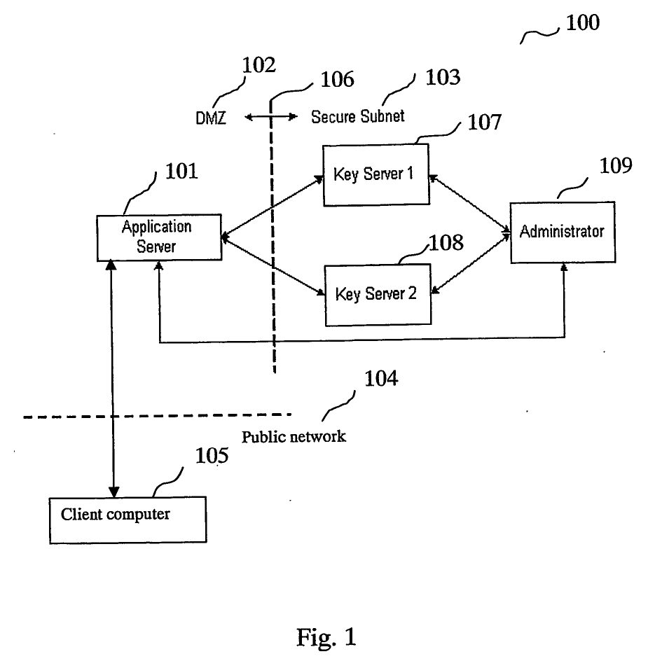

FIG. 1 shows a computer system according to an embodiment of the invention.

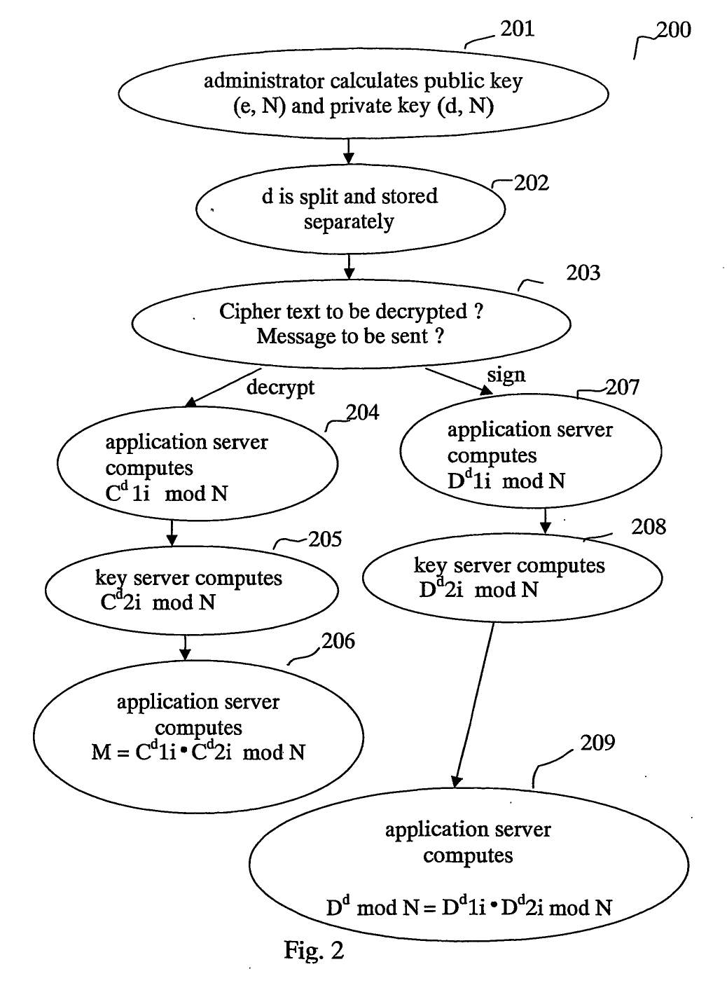

FIG. 2 shows a flow diagram according to an embodiment of the invention.

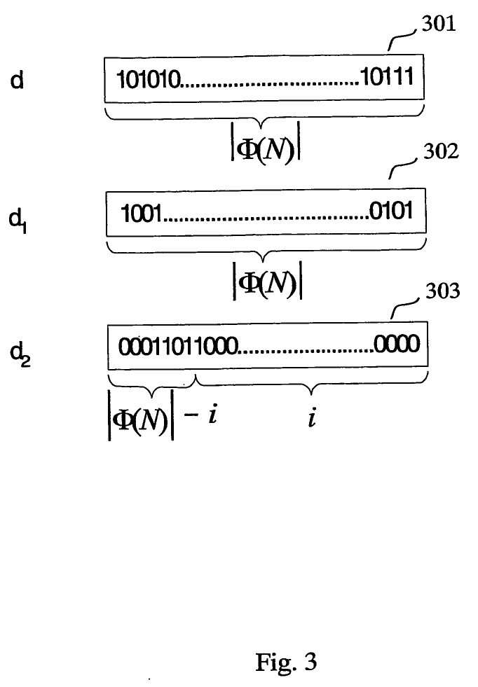

FIG. 3. shows a private key, a first private key part and a second private key part according to an embodiment of the invention.

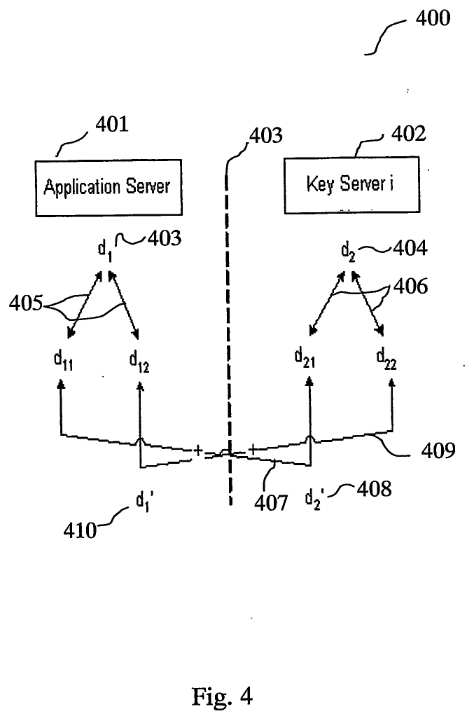

FIG. 4 shows a flow diagram according to an embodiment of the invention.

FIG. 1 shows a computer system 100 according to an embodiment of the invention.

The computer system 100 comprises an application server computer 101, which resides in a DMZ 102. The DMZ 102 (demilitarised zone) is a subnetwork that is located between a secure subnet 103 and a public network 104 which is publicly accessible.

The secure subnet 103 is e.g. a corporate private LAN (local area network), the public network 104 is e.g. the Internet.

A client computer 105 resides in the public network 104 which is coupled to the application server computer 101.

Some web application runs on the application server computer 101 and the application server computer 101 serves the client computer 105 according to the web application. For example, the application server computer 101 hosts the web side of the enterprise which owns the secure subnet 103.

The secure subnet 103 comprises a first key server computer 107 and a second key server computer 108 and an administrator 109, i.e., a computer system used by an administrator of the secure subnet 103.

The secure subnet 103 is protected at the boundary to the DMZ 102 by a firewall computer 106.

The application server computer 101 is responsible for the processing of secure operations, e.g. SSL (secure socket layer) authentication of the client computer 105, decryption of encrypted data sent from the client computer 105 to the application server computer 101 and signing messages sent by the application server computer 101 to the client computer 105.

In the following, the process of a secure communication between the application server computer 101 and the client computer 105, in particular the process of decrypting a message sent to the application server computer and encrypted by the client computer 105 and the process of signing a message sent from the application server computer 101 to the client computer 105 according to an embodiment of the invention is explained.

FIG. 2 shows a flow diagram 200 according to an embodiment of the invention.

In the embodiment of the invention now described with reference to FIG. 1 and FIG. 2, the RSA algorithm, for example described in [1], is used. The following denotations are used:
N: modulus, product of two large prime numbers p and q, i.e.
   N=p*q (1)
e: Public exponent
d: Secret exponent, which satisfies
   ed=1 modΦ(N) (2)
   where
   Φ(N)=(p−1)(q−1) (3)
M: Message (to be encrypted)
C: Cipher text
D: Cryptographic digest of message M

To encrypt a message M, i.e. to form a cipher text C according to the message M, C is computed according to
C=M^{e} mod N (4)

Thereby, it is assumed that the message M has the form of an integer, which is smaller than N. Large messages are broken up into smaller messages, such that the smaller messages can each be expressed as integers smaller than N.

To decrypt the cipher text C, i.e. to reconstruct the message M from the cipher text C, one calculates
M=C^{d} mod N (5)
To sign a message M, one calculates
D^{d} mod N (6)

D is computed from M by some hashing algorithm. For example, D can be generated using MD2, MD4, MD5, the SHA-0 (Secure Hash Algorithm) or the SHA-1.

In step 201, the administrator 109 determines a public key (e, N) and a corresponding private key (d, N) for use with the RSA algorithm.

The administrator can generate the key-pair. Alternatively, the key-pair might already exist and the administrator just splits the already existing key. This should also be reflected in FIG. 2.

The public key can be made known to users in the public network 104 by a certificate, which is digitally signed by a corresponding certificate authority. The administrator 109 creates the public key and the private key using standard key generation techniques.

In step 202 the number d is split into a number of shares according to
d=d₁+d₂+d₃+. . . +d₁ (7)

Wherein d₁, d₂, d₃, . . . ,d₁(1 integer) are the parts of d, which is in the following referred to as the private key (although, to be exact, the private key is made up of d and N).

Each share can be stored on a different key server computer 107, 108 (accordingly, the secure subnet 103 can comprise a multiplicity of key server computers). In this embodiment, it is assumed that d is split into two parts according to some decomposition, i.e.,
d=d_{11+d}₂₁ (8)
or (according to another decomposition)
d=d₁₂+d₂₂ (9)
Generally, this is written as
d=d₁ᵢ+d₂ᵢ (10)
in which d₁ᵢ and d₂ᵢ are selected random integers. d₁ᵢ is then assigned to the application server computer, i.e., is stored on the application server computer and d₂ᵢ is stored on the key server computer 107, 108. Preferably, d₂ᵢ (which corresponds to a decomposition which is assigned the number i) is stored on the i^{th} key server computer, i.e., one of the key server computers 107, 108 which is assigned the number i. In this embodiment, it is assumed that d₂ᵢ is stored on the first key server computer 107.

It is assumed that in step 203 a cipher text has to be decrypted or a message digest has to be signed. First, it is explained how a cipher text is decrypted according to this embodiment.

The cipher text, which is denoted by C, is generated from a message M by using the public key generated in step 201. The cipher text C is e.g. sent to the application server computer 101 by the client computer 105. For example, the client computer 105 used the public key generated in step 201 to encrypt a message to create the cipher text C.

According to the message M, C is assumed to be an integer generated according to equation (4).

To decrypt the cipher text C, the application server computer 101 in step 204 first computes
C^{d}1i mod N (11)

Then, the application server computer 101 passes C to the first key server computer 107, which is assumed as mentioned above to hold the share d₂ᵢ of the private key.

In step 205, the first key server computer 107 computes
C^{d}2i mod N (12)
and sends the result to the application server computer 101. Using the results of the calculations according to formulas (11) and (12) the application server computer 101 computes
C^{d}1i*C^{d}2i mod N=C^{(d}1i^{+d}2i) mod N=C^{d} mod N=M (13)
in step 206.7

Thus, the cipher text C is decrypted and the message M is reconstructed.

The application server computer 101 might calculate its partial decryption according to equation (11) at the same time as the first key server computer 107. It can pass the cipher text to the first key server computer 107 and while the first key server computer 107 is computing its partial decryption according to equation (12), the application server 101 creates its partial decryption at the same time.

Now, the process for signing a message digest D is explained.

The message digest D is e.g. generated by the application server computer 101 from the message M, which has to be sent from the application server computer 101 to the client computer 105, by using a hash function.

In step 207 the application server computer 101 calculates a partial signature according to
D^{d}1i mod N (14)

Then, the application server computer 101 sends D to the first key server computer 107. In step 208, the first key server computer 107 computes
D^{d}2i mod N (15)
and sends the result to the application server computer 101.

As above, the application server 101 might calculate its partial signature according to equation (14) at the same time as the first key server computer 107. It can pass D to the first key server computer 107 and while the first key server computer 107 is computing its partial signature according to equation (15), the application server 101 creates its partial decryption at the same time.

Analogously to formula (13) the application server computer 101 computes in step 209 the signature according to
D^{d}1i*D^{d}2i mod N=D^{(d}1i^{+d}2i) mod N=D^{d} mod N (16)
So, the application server computer 101 does not perform the security functions all by itself, but cooperates with the key server computers 107, 108, in this example with the first key server computer 107, for performing security operations, such as decryption or signing.

The key server computers 107, 108 are located inside the secure subnet 103 and are well protected-by the firewall computer 106. As mentioned, the private key shares are stored by the key server computers 107, 108 to assist any secure function of the application server computer 101 (in this example the private key share d₂ᵢ is stored by the first key server computer 107).

The administrator 109 is responsible for the generation of private keys and public keys, maintaining the secure configuration and monitoring the status. In case of any discrepancies, the administrator 109 can react accordingly.

The application server computer 101 is cooperating with the key server computers 107, 108 via secure channels, i.e., all data transferred from the application server computer 101 to the key server computers 107,108 according to the process described above with reference to FIG. 2 is transferred via secure channels. Since the private key d is split into two parts d₁ᵢ and d₂ᵢ, the application server computer 101 has to interact with the first key server computer 107, i.e. with the one of key server computer 107, 108, which holds the part of the private key not stored in the application server computer 101.

Illustratively, the application server computer 101 performs part of the security functions using its private key part and one of the key server computers 107, 108 performs another part of the security functions using its private key part. The application server computer 101 combines, as described in steps 206 and 209, the two partial results together. According to this embodiment, the private key parts d¹ⁱ and d²ⁱ are never combined to create the complete private key d.

Monitoring the current operation status, the administrator 109 is aware of the whole system security.

In the following, the process for splitting a private key d according to an embodiment of the invention is explained.

FIG. 3 shows a private key 301, denoted by d, a first private key part 302, denoted by d₁, and a second private key part 303, denoted by d₂, according to an embodiment of the invention.

Let |Φ(N)| denote the number of bits in Φ(N). Since e is chosen a small number (e.g. 3) and because of equation (2), the number of bits in a binary representation of d is close to |Φ(N)|. |Φ(N)| is the upper bound of the number of bits in a binary representation of d.

As shown above, in a description operation or signing operation, the application server computer 101 has to compute x^{d1} mod N, where X is C or D. The application server computer 101 does this by computing
X^{2ˆj} mod N, (for j=0, 1, 2, . . . , |(N)|). (17)

Analogously, the first key server computer 107 has to compute X^{d}2 mod N. It is not efficient, if the first key server computer 107 also performs all computations according to equation (17). Therefore, the following procedure for calculating a first private key part 302 and a second private key part 303 of the private key 301 such that
d=d₁+d₂ (18)
is preferred. First a number i is chosen. Then, the lower i bits of the second private key part 303 are set to zero. The higher |Φ(N)|-i bits of the second private key part 303 are randomly assigned.

The first private key part 302 is now calculated according to
d₁=d−d₂. (19)

Since at least i digits of the second private key part 303, i.e., of d₂, are zero, much computation time on computing X can be saved, since the computations according to equation (17) have only to be performed for at most |Φ(N)|-i values of j. The computation load of the first key server computer 107 can thus be reduced significantly.

After splitting the private key 301, the administrator 109 can store the private key 301 in some secure location, e.g. offline, or can delete the private key 301, since it is easy to construct the private key 301 from the first private key part 302 and second private key part 303.

For ensuring security, according to one embodiment of the invention, the decomposition of the private key d into two parts is changed at some times, referred to as refresh periods.

So, if a hacker succeeds in attacking the application server computer 101 and knows the part of the private key d stored in the application server computer 101, the security of the system is only compromised, if the hacker also succeeds to get the other part of the private key until the next refresh period.

A process for calculating a new composition of a private key is now explained with reference to FIG. 4.

FIG. 4 shows a flow diagram 400 according to an embodiment of the invention.

The processing steps of the flow diagram 400 are carried out by an application server computer 401, e.g. the application server computer 101, and a key server computer 402, e.g. one of the key server computers 107, 108. As above, the application server computer 401 and the key server computer 402 communicate via fire wall 403.

Let at the beginning of a refresh period a first private key share 403, denoted by d₁, be stored on the application server computer 401 and a second private key share 404, denoted by d₂, be stored on the key server computer 402. According to equation (18), the first private key share 403 and the second private key share 404 form a private key denoted by d, which is used for decryption and signing purposes as described above.

In step 405 the application server computer 401 computes a decomposition of the first private key share 403 according to
d₁=d₁₁+d_{12.} (20)

Analogously, the key server computer 402 computes in step 406 a decomposition of the second private key share 404 according to
d₂=d₂₁+d_{22.} (21)

In step 407, the application server computer 401 sends d₁₁ to the key server computer 402, which forms a refreshed private key share 408, denoted by d₂′, according to
d₂′=d₂₁+d_{11.} (22)

Analogously, in step 409, the key server computer 402 sends d₂₂ to the application server computer 401, which forms a refreshed first private key share 410, denoted by d₁′, according to
d_{1′=d}₁₂+d₂₂ (23)

As mentioned above, there exist of plurality of decompositions of a private key d according to equation (10) for a plurality of different i. Preferably, all d₁ᵢ are stored on the application server computer 101, and the respective second private key share d₂ᵢ is stored on the i^{th} key server computer. The application server computer 101 can now depending on the work load of the key server computers 107, 108, distribute the partial decryption or signature operations to different key server computers 107, 108. According to the key server computer 107, 108, the application server computer 101 distributes the partial operation to, the application server computer 101 has to use the corresponding private key share, i.e. the application server computer 101 has to use d₁ᵢ for the partial operation performed by the application server computer 101, if a partial operation is distributed to the i^{th} key server computer. As described above with reference to FIG. 2, the application server computer 101 combines the results of the partial operations.

As earlier indicated, in FIG. 2, it is not always necessary for the administrator to generate the keys. The principal aim of the administrator is to split the keys and manage the split keys. Key generation can be done by the administrator but not necessary.

In this document, the following publication is cited:
[1] R. L. Rivest, A. Shamir, and L. M. Adleman, “A method for obtaining digital signatures and public key cryptosystems”, Communications of the ACM, Vol. 21, No., 2, Feb. 1978, pp. 120-126

1-19. (canceled)

20. Method for cryptographically processing a message, wherein—a first partial cryptographic key and a second partial cryptographic key, which correspond to a decomposition of a private cryptographic key, are used;
the message is processed using the first partial cryptographic key resulting in a first partially processed message;
the message is processed using the second partial cryptographic key resulting in a second partially processed message;
the first partially processed message and the second partially processed message are combined resulting in a cryptographically processed message,
wherein further at selected times and after or before the message is processed, a refreshed decomposition is determined and wherein the refreshed decomposition is determined by decomposing the first partial cryptographic key and the second partial cryptographic key and combining these decompositions to form a decomposition of the private cryptographic key.

21. The method according to claim 20, wherein the processing of the message using the first partial cryptographic key is carried out by a first computer and the processing of the message using the second partial cryptographic key is carried out by a second computer.

22. The method according to claim 21, wherein the first and the second computer are coupled via a computer network.

23. The method according to claim 21, wherein the method further comprises the step of transmitting the message from the first computer to the second computer.

24. The method according to claim 20, wherein the first partial cryptographic key and the second partial cryptographic key correspond to a decomposition of the private cryptographic key into a plurality of partial cryptographic keys.

25. The method according to claim 24, wherein the plurality of partial cryptographic keys give, when summed, the private cryptographic key.

26. The method according to claim 20, wherein the cryptographical processing of the message is the signing of the message or the decrypting of a message.

27. The method according to claim 20, wherein the message is processed according to a public key cryptographic algorithm.

28. The method according to claim 27, wherein the public key cryptographic algorithm is the RSA algorithm.

29. Computer system comprising
a first processing unit which is adapted to process a message using a first partial cryptographic key, which corresponds to a decomposition of a private cryptographic key, resulting in a first partially processed message;
a second processing unit which is adapted to process a message using a second partial cryptographic key, which corresponds to the decomposition of the private cryptographic key, resulting in a second partially processed message;
a combining unit which is adapted to combine the first partially processed message and the second partially processed message resulting in a cryptographically processed message,
wherein further at selected times and after or before the message is processed, a refreshed decomposition is determined, wherein the refreshed decomposition is determined by decomposing the first partial cryptographic key and the second partial cryptographic key and combining these decompositions to form a decomposition of the private cryptographic key.

30. Method for generating a cryptographically processed message wherein
a message is processed using a first partial cryptographic key, which corresponds to a decomposition of a private cryptographic key, resulting in a first partially processed message;
the message is transmitted to a client computer;
a second partially processed message is received which is the message processed using a second partial cryptographic key which corresponds to the decomposition of the private cryptographic key;
the first partially processed message and the second partially processed message are combined to a cryptographically processed message,
wherein further at selected times and after or before the message is processed, a refreshed decomposition is determined, wherein the refreshed decomposition is determined by decomposing the first partial cryptographic key and the second partial cryptographic key and combining these decompositions to form a decomposition of the private cryptographic key.

31. Server computer comprising
a processing unit which is adapted to process a message using a first partial cryptographic key, which corresponds to a decomposition of a private cryptographic key, resulting in a first partially processed message;
a transmitting unit which is adapted to send the message to a client computer;
a receiving unit which is adapted to receive a second partially processed message which is the message processed using a second partial cryptographic key which corresponds to the decomposition of the private cryptographic key;
a combining unit which is adapted to combine the first partially processed message and the second partially processed message to a cryptographically processed message,
wherein further at selected times and after or before the message is processed, a refreshed decomposition is determined, wherein the refreshed decomposition is determined by decomposing the first partial cryptographic key and the second partial cryptographic key and combining these decompositions to form a decomposition of the private cryptographic key.

32. Method for performing a cryptographic operation on a message, wherein
a message is received;
the message is processed using a partial cryptographic key which corresponds to a decomposition of a private cryptographic key resulting in a partially processed message;
the partially processed message is transmitted to a server computer,
wherein further at selected times and after or before the message is processed, a refreshed decomposition is determined.

33. Client computer comprising
a receiving unit which is adapted to receive a message;
a processing unit which is adapted to process the message using a partial cryptographic key which corresponds to a decomposition of a private cryptographic key resulting in a partially processed message;
a transmitting unit which is adapted to transmit the partially processed message to a server computer,
wherein further at selected times and after or before the message is processed, a refreshed decomposition is determined.

34. Computer program element which, when executed by a computer, makes the computer perform the following steps
processing a message using a first partial cryptographic key which corresponds to a decomposition of a private cryptographic key, resulting in a first partially processed message;
processing the message using the second partial cryptographic key which corresponds to the decomposition of the private cryptographic key resulting in a second partially processed message;
combining the first partially processed message and the second partially processed message resulting in a cryptographically processed message,
wherein further at selected times and after or before the message is processed, a refreshed decomposition is determined, wherein the refreshed decomposition is determined by decomposing the first partial cryptographic key and the second partial cryptographic key and combining these decompositions to form a decomposition of the private cryptographic key.

35. Computer program element which, when executed by a computer, makes the computer perform the following steps
processing a message using a first partial cryptographic key which corresponds to a decomposition of a private cryptographic key resulting in a first partially processed message;
transmitting the message to a client computer;
receiving a second partially processed message which is the message processed using a second partial cryptographic key which corresponds to the decomposition of the private cryptographic key;
combining the first partially processed message and the second partially processed message to a cryptographically processed message,
wherein further at selected times and after or before the message is processed, a refreshed decomposition is determined, wherein the refreshed decomposition is determined by decomposing the first partial cryptographic key and the second partial cryptographic key and combining these decompositions to form a decomposition of the private cryptographic key.

36. Computer program element which, when executed by a computer, makes the computer perform the following steps
receiving a message;
processing the message using a partial cryptographic key which corresponds to a decomposition of a private cryptographic key resulting in a partially processed message;
transmitting the partially processed message to a server computer,
wherein further at selected times and after or before the message is processed, a refreshed decomposition is determined.
